(19) United States
(12) Patent Application Publication
(10) Pub. No.: US 2009/0172933 A1
(43) Pub. Date: Jul. 9, 2009

(54) PNEUMATIC CRIMPING TOOL

(76) Inventor: Wayne M. Hoffman, Mount Airy, MD (US)

Correspondence Address: LAUBSCHER & LAUBSCHER, P.C., 1160 SPA ROAD, SUITE 2B, ANNAPOLIS, MD, 21403, US

(21) Appl. No.: 12/348,548

(22) Filed: Jan. 5, 2009

Related U.S. Application Data
(60) Provisional application No. 61/018,871, filed on Jan. 3, 2008.

(51) Int. Cl. B23P 19/04

(52) U.S. Cl. 29/252

(57) ABSTRACT

A crimping tool includes an anvil having a crimping surface containing at least one channel and a clamp having a crimping surface containing at least one channel arranged opposite the anvil crimping surface. The clamp is displaceable between an open position where the clamp is spaced from the anvil and a closed position where the clamp abuts the anvil with the crimping surfaces being arranged in contiguous relation and the channels being arranged opposite each other. A drive mechanism displaces the clamp between the open and closed positions. When a fastener is arranged in the anvil channel and the clamp is displaced to the closed position, the fastener is compressed in the clamp and anvil channels to fasten a fishing line or other element therein.

This application claims the benefit of U.S. provisional application No. 61/018,871 filed Jan. 3, 2008.

### BACKGROUND OF THE INVENTION

Fishermen have long created their own lures, leaders, and fishing lines depending on the type of hook, lure and/or sinker being used in accordance with the type of fish being caught. There are many variables for fly fishing, trolling, bottom fishing and the like depending on the size and type of fish. When constructing their lines, it is common for fishermen to form a loop of line with a hook, lure or sinker within the loop. The line is then fastened to permanently retain the loop. A compressible fastener, typically having a cylindrical configuration, is used to fix the loop. The line is passed through the fastener and then reversed back through the fastener to form the loop. The fisherman then compresses the fastener with a pair of pliers or other crimping tool.

Depending on the size of the line and the number of loops being formed, manual operation of the crimping tool becomes cumbersome and tiresome. After a relatively short period of time, it is difficult to consistently crimp the fastener with enough force to permanently retain the fastener on the line and thus retain the loop therein. In addition, elderly fishermen often do not have the grip strength to adequately crimp the fastener.

The present invention was developed in order to overcome these drawbacks by providing a powered crimping tool which is capable of compressing a variety of sizes of fasteners in a quick and easy operation.

### SUMMARY OF THE INVENTION

Accordingly, it is a primary object of the invention to provide a crimping tool including an anvil having a crimping surface which contains a plurality of spaced parallel channels of different diameters. The tool also includes a clamp having a crimping surface which contains corresponding spaced parallel channels. A drive mechanism is connected with the clamp and displaces it between open and closed positions. In the open position, the clamp is spaced from the anvil to allow a fastener to be arranged in a channel of the anvil crimping surface in accordance with the diameter of the fastener. In the closed position, the clamp abuts the anvil with the channels of the crimping surfaces being arranged opposite each other. As the clamp moves toward the closed position, the fastener is compressed. A fishing line arranged in the fastener is thus secured within the fastener.

According to a further object of the invention, the drive mechanism is a pneumatic cylinder.

### BRIEF DESCRIPTION OF THE FIGURES

Other objects and advantages of the invention will become apparent from a study of the following description when viewed in the light of the accompanying drawing, in which:

FIG. 1 is an exploded perspective view of the pneumatic crimping tool according to the invention;

FIG. 2 is a perspective view of the clamp and anvil of the tool of FIG. 1;

FIGS. 3a and 3b are front plan views of the clamp and anvil, respectively;

FIGS. 4a and 4b are top sectional views of the clamp and anvil taken along lines 4a-4a and 4b-4b of FIGS. 3a and 3b, respectively; and

FIG. 5 is a perspective view of a fastener on which the crimping tool operates.

### DETAILED DESCRIPTION

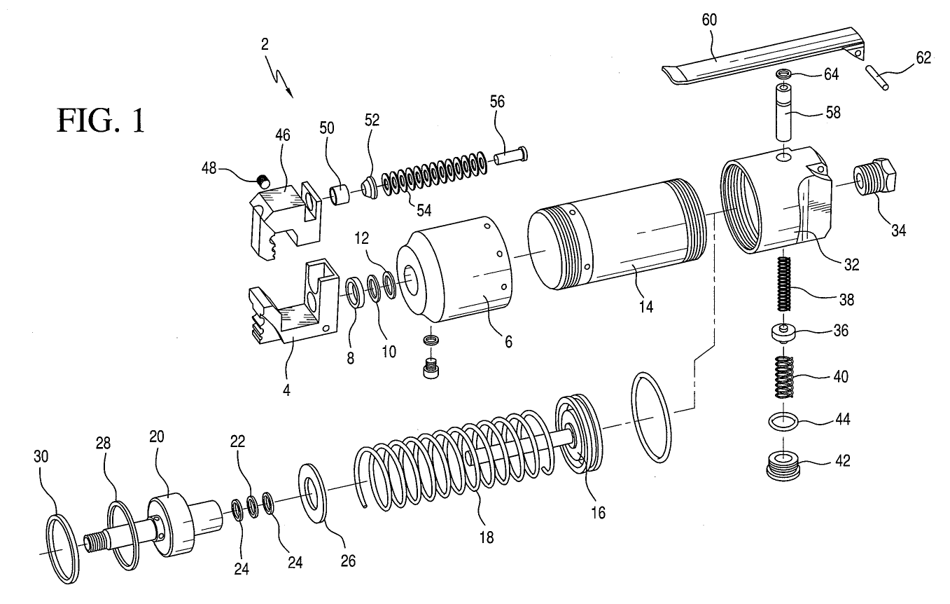

The pneumatic crimping tool according to the invention will first be described with reference to FIG. 1. As shown therein, the tool 2 includes an anvil 4 connected with a hydraulic cylinder 6 via an oil seal 8, a support ring 10 and an O-ring 12. The hydraulic cylinder is connected with an air cylinder 14 within which is provided a piston 16 surrounded by a spring 18. A hydraulic piston 20 of the hydraulic cylinder is connected with the piston 16 of the air cylinder via a support ring 22 having O-rings 24 on either side thereof and a spring washer 26. A support ring 28 and an O-ring 30 are provided for the hydraulic piston 20.

The air cylinder 14 is mounted in a housing 32 including an air inlet plug 34. A valve 36 for the housing has springs 38, 40 on either side thereof and is connected with the housing by a screw 42. An O-ring 44 is provided to seal the screw 42 and the valve 36.

A clamp 46 having a set screw 48 is connected with the hydraulic cylinder via a punch die 50, a guide bushing 52, a series of cup springs 54 and a punch 56. The clamp can be displaced relative to the anvil by operation of the hydraulic and air cylinders. More particularly, a push rod 58 connected with the housing 32 operates the valve 25 of the air cylinder to supply or release air from the cylinder to displace the pistons. A throttle lever 60 is pivotally connected with the housing via a pivot pin 62 to activate the push rod 58. An O-ring 64 seals the push rod within the housing.

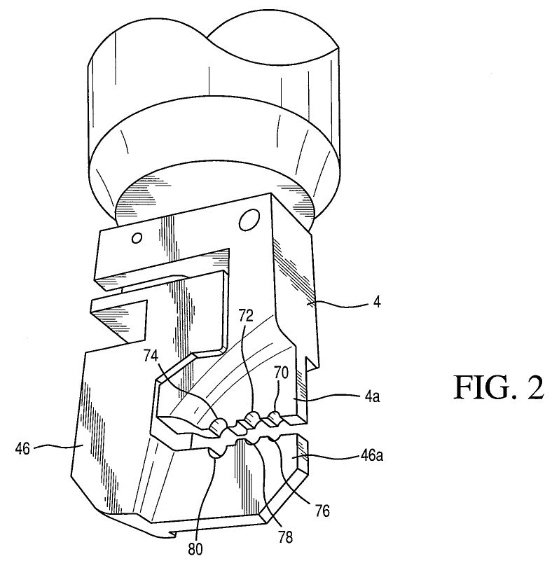

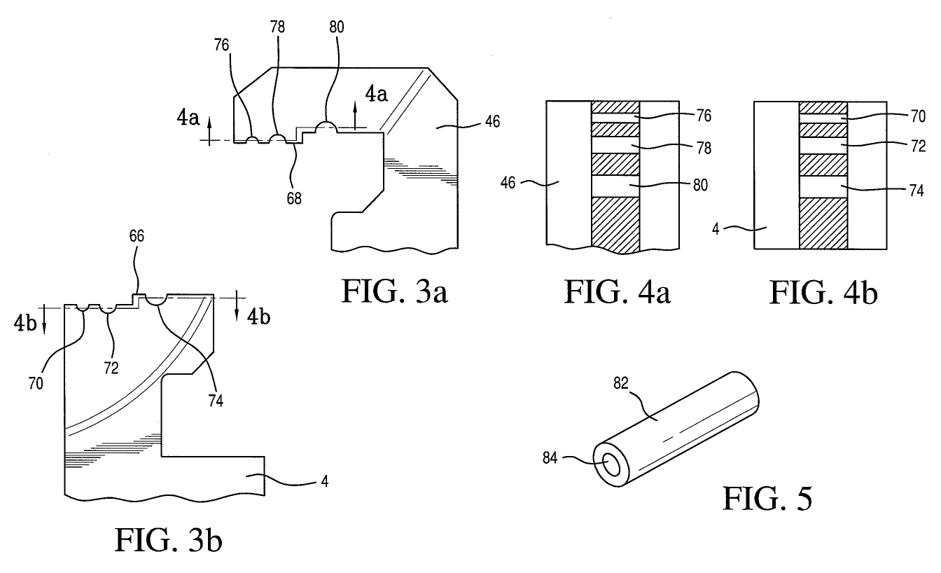

Referring to FIGS. 2-4, the anvil 4 and clamp 46 of the crimping tool will be described in greater detail. The anvil has a crimping surface 66 and the clamp has a crimping surface 68. These surfaces are arranged opposite one another as shown in FIGS. 2 and 3. If desired, the crimping surfaces may have a stepped configuration. Each crimping surface contains a plurality of channels. More particularly, the anvil crimping surface contains channels 70, 72, and 74 and the clamp crimping surface contains channels 76, 78, and 80. As shown in the drawing, the channels are arranged opposite each other and have progressively larger diameters.

The hydraulic and air cylinders serve as a drive mechanism of the crimping tool and displace the clamp between an open position where the clamp is spaced from the anvil and a closed position where the clamp abuts the anvil with the respective crimping surfaces being in contiguous relation. When the clamp is in the closed position, the channels thereof are aligned with corresponding channels in the anvil.

FIG. 5 illustrates a fastener 82 to be crimped by the crimping tool of the invention. The fastener has a generally cylindrical or elliptical configuration and contains a longitudinal opening 84. A linear element such as a piece of fishing line is passed through the opening, formed into a loop, and then passed back through the opening in a reverse direction. With the clamp in the open position, the fastener is arranged in a channel of the anvil and the crimping tool is operated to displace the clamp toward the anvil, compressing the fastener in the process to secure the line therein. Because the tool includes channels of different diameters, different sized fasteners may be accommodated.

Referring once again to FIG. 2, it will be seen that the anvil 4 and clamp 46 are narrowed to define crimping surfaces that are narrower than the remaining portion of each element. The narrowed portions 46a of the clamp and 4a of the anvil are defined by removing a portion of each element along a tapered line as shown in FIG. 2. This facilitates arrangement of fasteners in the channels of the crimping tool and also improves the performance of the tool.

In addition to fishing line, the tool may also be used by electrical contractors to crimp a fastener on electrical wires of different gauges. The tool is suitable for use with any type of compression fastener in any type of environment.

While the preferred forms and embodiments of the invention have been illustrated and described, it will be apparent to those of ordinary skill in the art that various changes and modifications may be made without deviating from the inventive concepts set forth above.

What is claimed is:

1. A crimping tool, comprising
(a) an anvil having a crimping surface containing at least one channel;
(b) a clamp having a crimping surface containing at least one channel arranged opposite said anvil crimping surface, said clamp being displaceable between an open position where said clamp is spaced from said anvil and a closed position where said clamp abuts said anvil with said crimping surfaces being arranged in contiguous relation and said channels being arranged opposite each other;
(c) a drive mechanism for displacing said clamp between said open and closed positions, whereby when a fastener is arranged in said anvil channel and said clamp is displaced to said closed position, said fastener is compressed within said clamp and anvil channels to grip a linear element arranged therein.

2. A crimping tool as defined in claim 1, wherein said anvil and said clamp crimping surfaces contain a plurality of spaced parallel channels.

3. A crimping tool as defined in claim 2, wherein said spaced parallel channels each have different diameters, the channels of each diameter being arranged opposite each other when said clamp is in said closed position, whereby fasteners of different size may be accommodated within the tool.

4. A crimping tool as defined in claim 2, wherein said drive mechanism comprises a pneumatic cylinder.
